(19) United States
(12) Patent Application Publication
(10) Pub. No.: US 2010/0220352 A1
(43) Pub. Date: Sep. 2, 2010

(54) IMAGE FORMING APPARATUS, IMAGE FORMING SYSTEM, AND INFORMATION PROCESSING METHOD

(76) Inventor: Kiyohiro HYO, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/634,235

(22) Filed: Dec. 9, 2009

(30) Foreign Application Priority Data
Feb. 27, 2009 (JP) NO. 2009-046564

(51) Int. Cl. G06F 15/00

(52) U.S. Cl. 358/1.15

(57) ABSTRACT

An image forming apparatus includes a function realizing unit performing a function in accordance with a request sent from a client device in a first description format. A request analyzing unit analyzes the request to acquire function realizing unit identifying information and a request item. A format of the request item is converted into a corresponding data format of the function realizing unit or a second description format, depending on whether the corresponding description format is available. The image forming apparatus generates a response in the first description format based on a response item that is outputted by the function realizing unit in the corresponding data format or in the second description format, indicating whether the request item has been processed by the function realizing unit.

### BACKGROUND OF THE INVENTION

1. Field of the Invention

The present invention relates to image forming apparatuses, image forming systems, and information processing methods.

2. Description of the Related Art

Various version-upgrading technologies for updating the firmware of devices connected via a network are known. Japanese Laid-Open Patent Application No. 2004-139572 discloses a remote management system for preventing decrease in the utilization ratio of image forming apparatuses by scheduling the updating of their firmware to occur at a predetermined time or date. Japanese Laid-Open Patent Application No. 2004-252704 discloses an apparatus managing apparatus that ensures that multiple apparatuses connected via a network have the same version of installed software.

However, neither of the foregoing technologies take into consideration the ease with which a new function may be incorporated in such an image forming apparatus connected to a network. For example, in an image forming apparatus into which a new function has been incorporated, firmware for controlling the output of instructions regarding various functions of the image forming apparatus may be updated in addition to updating firmware for realizing the various functions of the image forming apparatus in order to allow the execution of the new function. In this way, however, considerable time and effort would be required for managing the version-upgrade of the firmware or newly developing firmware each time a new function is added or a new combination of functions is incorporated.

### SUMMARY OF THE INVENTION

The aforementioned disadvantages may be overcome by the present invention which, in one aspect, is an image forming apparatus including a function realizing unit configured to perform a function in accordance with a request item contained in a request sent from a client device connected to the image forming apparatus; a communication unit configured to receive the request from the client device in a first description format; a request analyzing unit configured to analyze the request received by the communication unit to acquire identifying information of the function realizing unit and the request item from the request; a data format retaining unit configured to retain a corresponding data format for the function realizing unit; a processed content acquiring unit configured to acquire processed content by converting a format of the request item into the corresponding data format of the function realizing unit that is retained in the data format retaining unit, based on an output of the request analyzing unit, the processed content acquiring unit being configured to convert the format of the request item into a second description format when the corresponding data format is not retained in the data format retaining unit; and a response generating unit configured to generate a response in the first description format based on a response item that is outputted by the function realizing unit in the corresponding data format or in the second description format when the corresponding data format is not retained in the data format retaining unit.

The response item is described in the response indicating whether the request item has been processed by the function realizing unit.

In another aspect of the present invention, an image forming system includes a client device; and an image forming apparatus connected to the client device. The client device includes a request generating unit configured to generate a request containing a request item directed to the image forming apparatus in a first description format; and a first communication unit configured to transmit the request to the image forming apparatus. The image forming apparatus includes a function realizing unit configured to perform a function in accordance with the request item contained in the request sent from the client device; a second communication unit configured to receive the request from the client device in the first description format; a request analyzing unit configured to analyze the request received by the second communication unit to acquire identifying information of the function realizing unit and the request item from the request; a data format retaining unit configured to retain a corresponding data format for the function realizing unit; a processed content acquiring unit configured to acquire processed content by converting a format of the request item into the data format of the function realizing unit that is retained in the data format retaining unit, based on an output of the request analyzing unit, the processed content acquiring unit being configured to convert the format of the request item into a second description format when the corresponding data format is not retained in the data format retaining unit; and a response generating unit configured to generate a response in the first description format based on a response item that is outputted by the function realizing unit in the corresponding data format or in the second description format when the corresponding data format is not retained in the data format retaining unit.

The response item is described in the response indicating whether the request item has been processed by the one function realizing unit.

In another aspect of the present invention, there is provided an information processing method for an image forming apparatus including a function realizing unit and a data format retaining unit configured to retain a corresponding data format for the function realizing unit. The method includes receiving a request from a client device in a first description format, the request containing a request item; analyzing the request received in the receiving step to acquire identifying information of the function realizing unit and the request item from the request; acquiring processed content by converting a format of the request item into the corresponding data format of the function realizing unit that is retained in the data format retaining unit, based on an output of the analysis; converting the format of the request item into a second description format when the corresponding data format is not retained in the data format retaining unit; generating a response in the first description format based on a response item that is outputted by the function realizing unit in the corresponding data format or in the second description format when the corresponding data format is not retained in the data format retaining unit; and indicating in the response whether the request item has been processed by the function realizing unit.

### BRIEF DESCRIPTION OF THE DRAWINGS

Other objects, features and advantages of the present invention will become apparent upon consideration of the specification and the appendant drawings, in which:

FIG. 1 depicts an image forming system, illustrating the processing of a request by plural image forming apparatuses;

FIG. 2 illustrates a problem encountered in the image forming system of FIG. 1;

FIG. 3 illustrates the concept of including unprocessed data in response data;

FIG. 4 is a block diagram of an image forming system according to an embodiment of the present invention;

FIG. 5 is a block diagram of an MFP (multifunction peripheral) as an image forming apparatus in the embodiment of FIG. 4;

FIG. 6 is a block diagram illustrating a functional structure of the image forming system according to the present embodiment;

FIG. 7 is a sequence diagram of a process based on a request from a client;

FIG. 8 is a sequence diagram of a process based on a request from a client in which a response is transmitted;

FIG. 9 is a sequence diagram of a process of transmitting a message based on an event;

FIG. 10 is a flowchart of a process of analyzing a request;

FIG. 11 depicts an exemplary request;

FIG. 12 illustrates a process of converting a request item into a second description format;

FIG. 13 depicts examples of requests containing unprocessed data;

FIG. 14 is a flowchart of a process of generating a response or a message;

FIG. 15 illustrates a process of generating a response in a first description format from a response item in the second description format;

FIG. 16 illustrates a process of generating a response in the first description format from a response item from an unwanted data list;

FIG. 17 illustrates a process of generating a response in the first description format from a response item in an unsupported data list;

FIG. 18 depicts a first example of a response;

FIG. 19 depicts a second example of a response;

FIG. 20A depicts an exemplary message;

FIG. 20B depicts an exemplary response outputted by a client PC; and

FIG. 21 is a block diagram of a computer for realizing the image forming apparatus or the client device according to an embodiment of the present invention.

### DETAILED DESCRIPTION OF THE PREFERRED EMBODIMENTS

### Processing of A Request By Multiple Devices

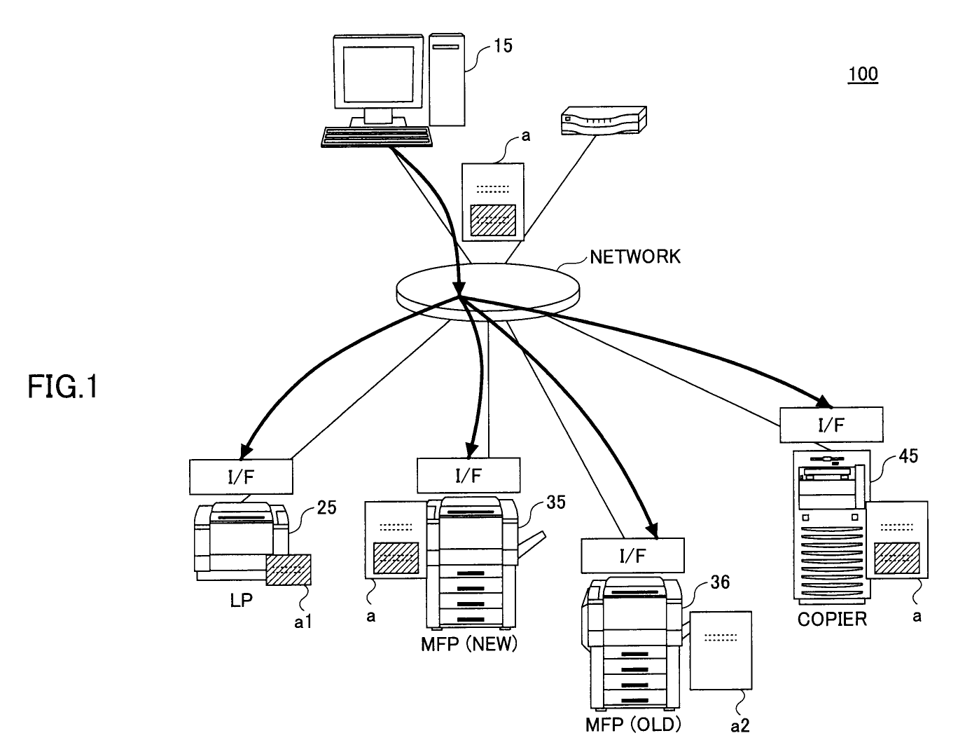

Embodiments of the present invention are described below referring to the drawings. The same reference numerals designate identical or corresponding parts throughout. FIG. 1 depicts an image forming system 100, in which a request is processed by plural image forming apparatuses. The image forming system 100 includes a personal computer (“PC”) 15 as a client device. The PC 15 is connected to the multiple image forming apparatuses, including a laser printer (“LP”) 25, a newer multifunction peripheral (“MFP”) 35, an older MFP 36, and a copier 45 via a network. The LP 25, the newer MFP 35, the older MFP 36, and the copier 45 may use the same interface technology based on the same protocol for transmission of requests and reception of responses.

The image forming system 100 utilizes a request data format, such as XML format. The image forming apparatuses only process request items in a request “a” from the PC 15 that correspond to the individual function realizing units of the image forming apparatuses. For example, the LP 25 only processes a request item in a portion “a1” of the request “a” that corresponds to its function realizing unit. The older MFP 36 processes a request item in a portion “a2” of the request that corresponds to its own function realizing unit. The newer MFP 35 and the copier 45 process all request items in the request “a” because they have function realizing units corresponding to all of the request items in the request “a”. Such selection of relevant request items may be performed by a Web Service (“WS”) unit of each of the image forming apparatuses. Thus, in the image forming system 100 depicted in FIG. 1, the PC 15 can output a request without considering the function realizing units of the individual image forming apparatuses. This eliminates the need to modify the function realizing unit of the client (PC 15) in accordance with the function realizing units or their version of the individual image forming apparatuses.

The PC 15 may access the image forming apparatuses in the image forming system 100 by one of the following two methods:
1. Access information in an MIB (Management Information Base) over SNMP (Simple Network Management Protocol).
2. Utilize SOAP (Simple Object Access Protocol) or XML data over HTTP (Hyper Text Transfer Protocol).

In method 1, although the PC 15 can access any information defined in the MIB of any of the image forming apparatuses, it cannot access other information. On the other hand, in method 2, the PC 15 can access, using SOAP or XML, the information in each apparatus for which an interface is defined on an individual device basis. However, in method 2, if the interfaces are different due to differences in the platforms or versions, the PC 15 needs to perform a process to accommodate the difference. With reference to the present embodiment, the term “interface” is intended to refer to a “network interface” unless otherwise specified. Such network interface may include information enabling the identification and calling of a device, such as a URL in the case of SOAP.

### Response Problem

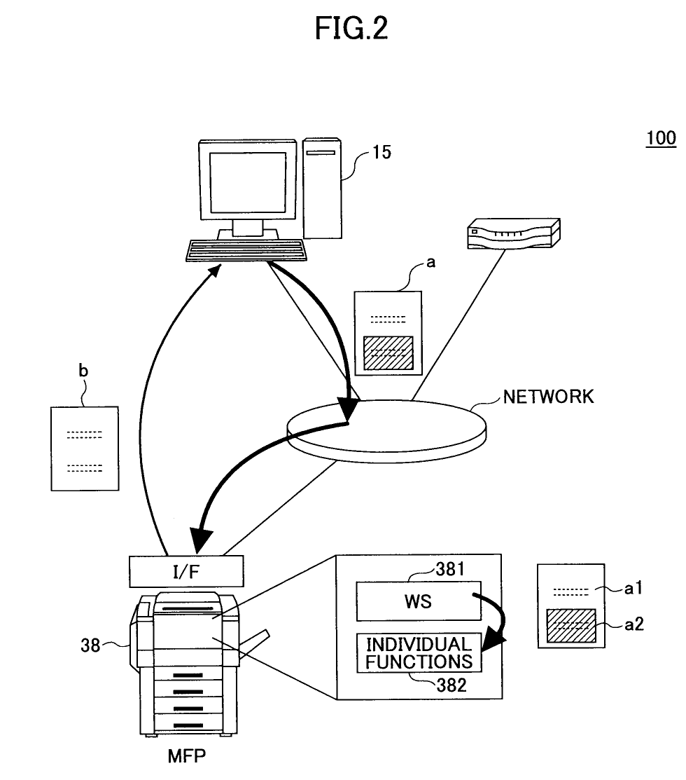

With reference to FIG. 2, a problem involved in a response is described. In a conventional method, a WS unit 381 in a MFP 38 transfers unknown data “a2” in the request “a” to a function realizing unit 382. If the function realizing unit 382 does not support or require the data a2, the function realizing unit 382 simply deletes the data a2. In this case, data in a response “b” from the MFP 38 only contains processed information, so that the client PC 15 cannot determine from the response “b” alone whether the data in the “a2” portion of the request “a” has been processed. Thus, because the client PC 15 sends the same request to plural apparatuses at once, the client PC 15 cannot determine which data has been processed by which apparatus based on the responses from the apparatuses.

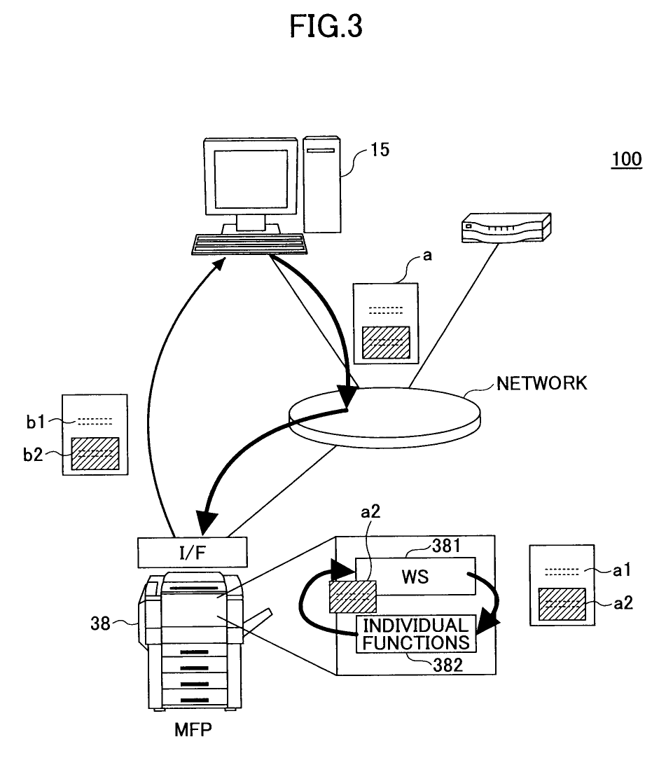

With reference to FIG. 3, the concept of including unprocessed data in the response data is described. It is now assumed that unknown data “a2” transmitted to the function realizing unit 382 is not processed by the function realizing unit 382 because the function realizing unit 382 does not support or require the data a2. In this case, data a3 corresponding to the unprocessed data a2 is delivered to the WS unit 381 when sending a response data generating request to the WS unit 381. The WS unit 381 then generates response data “b1” including a portion “b2” corresponding to the unprocessed data a2. Thus, the client PC 15 can determine which data has not been processed based on the response data b1.

The term “unsupported data” refers to data that the function realizing unit 382 cannot process because of difference in versions of the request and the function realizing unit 382. For example, if the request includes a new data item based on a new version but the MFP 38 is only compatible with an older version, the new item cannot be processed by the MFP 38. The term “unwanted data” refers to data that is not required by the image forming apparatus 38 because the MFP 38 lacks a function for processing the data contained in the request in the first place.

### System Configuration

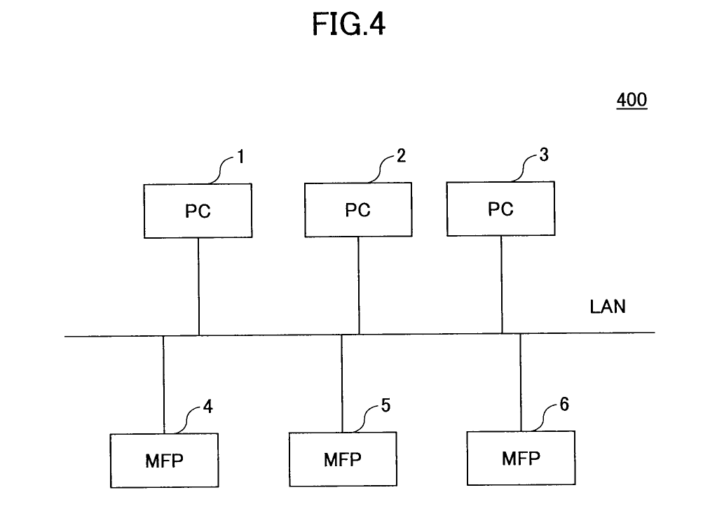

FIG. 4 is a block diagram of an image forming system 400 according to an embodiment of the present invention. The image forming system 400 may include plural PCs, such as PC 1, PC 2, and PC 3, and plural MFPs, such as MFP 4, MFP 5, and MFP 6, which are connected to a LAN (local area network). The PCs output requests to the MFPs, and receive responses from the MFPs.

### Structure of MFP

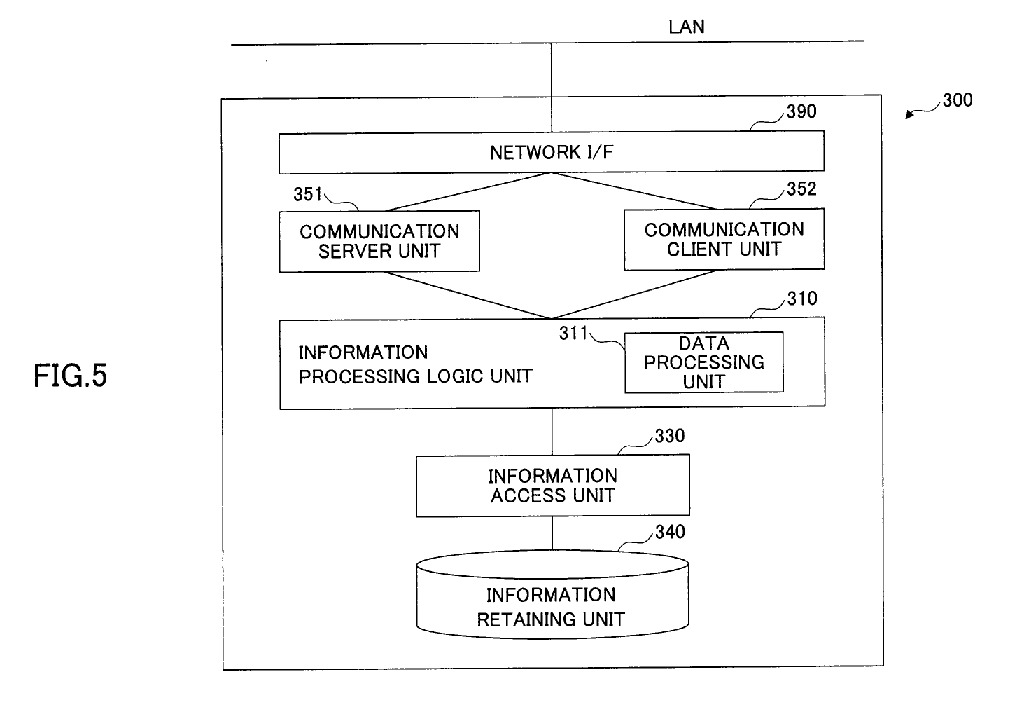

FIG. 5 is a block diagram of an MFP 300 as an image forming apparatus according to the present embodiment. The MFP 300 may include an information processing logic unit 310, an information access unit 330, an information retaining unit 340, a server unit 351, a client unit 352, and a network interface (“I/F”) 390. The information processing logic unit 310 may analyze a request from a client device and generate a response to the client device. The information processing logic unit 310 includes a data processing unit 311. The data processing unit 311 may parse a request in XML and generate a response described in XML. The information access unit 330, in accordance with a request item contained in the request analyzed by the information processing logic unit 310, may acquire, edit, or substitute for information retained in the information retaining unit 340, or generate information and store it in the information retaining unit 340.

The information retaining unit 340 may store information about the status of the image forming apparatus 300, identifying information of individual operators, and image data. The server unit 351 and the client unit 352 enable communication with the client device. The network I/F 390 provides an interface for connecting the image forming apparatus 300 to a LAN.

### Functional Structure of An Image Forming System

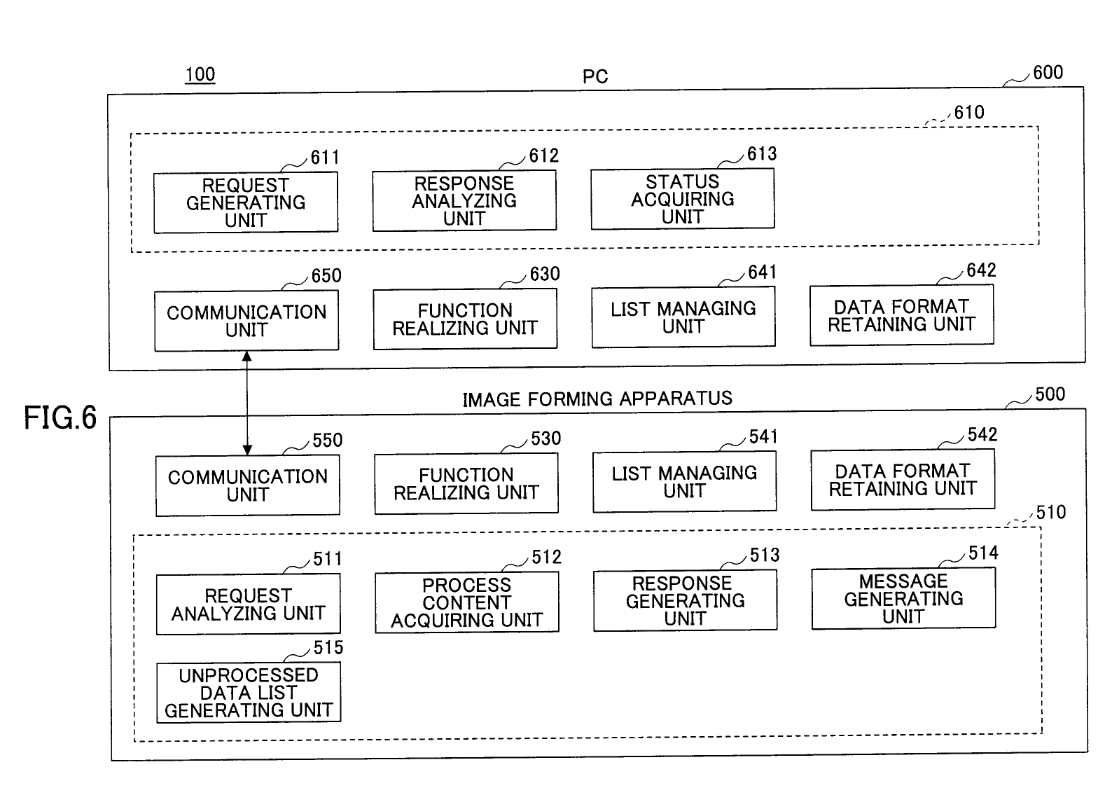

FIG. 6 is a block diagram illustrating a functional structure of an image forming system 700 according to an embodiment of the present invention. The image forming system 700 includes an image forming apparatus 500 and a client PC 600 connected to each other. The image forming apparatus 500 and the client PC 600 may be connected either via a network or directly. The image forming apparatus 500 includes an information processing logic unit 510, a function realizing unit 530, a list managing unit 541, a data format retaining unit 542, and a communication unit 550. The information processing logic unit 510 may analyze a request transmitted from the client PC 600 and acquire a request item contained in the request.

The information processing logic unit 510 may also generate a response in accordance with the request item. The information processing logic unit 510 includes a request analyzing unit 511, a processed content acquiring unit 512, an unprocessed data list generating unit 515, a response generating unit 513, and a message generating unit 514. The request analyzing unit 511 may analyze a request described in a first description format in accordance with the syntax of the format. The first description format may include a description format in XML in which groups of items are identified by namespace. The request analyzing unit 511 may include an XML parser configured to acquire a request item contained in a request.

The processed content acquiring unit 512, based on a result of analysis by the request analyzing unit 511, may acquire identifying information of the function realizing unit 530 and processed content of the request item. For example, the processed content acquiring unit 512 converts the format of the request item into the data format of the function realizing unit 530, which data format is retained in the data format retaining unit 542. The processed content acquiring unit 512, if unable to acquire the corresponding data format, may convert the request item into a predetermined description format. The predetermined description format, which may be referred to as a “second description format”, may be defined as a class including a namespace name, a variable or a tag name, and a value.

The corresponding data format may not be acquired when the function realizing unit 530 corresponding to the request item has been newly added so that, although its identifying information is managed by the list managing unit 541, no corresponding data format providing an interface between the function realizing unit 530 and the relevant data is registered in the data format retaining unit 542. Thus, a request item corresponding to a newly added function realizing unit 530 of the image forming apparatus 500 can be outputted to request a process.

The unprocessed data list generating unit 15 creates a list of unprocessed data that has not been processed by the function realizing unit 530. The unprocessed data list 515 may include entries of unsupported data and unwanted data, as mentioned above. The unprocessed data list generating unit 515 may create a list of unsupported data that has not been processed by the function realizing unit 530 as having incompatible versions. The unprocessed data list generating unit 515 may also acquire from the processed content acquiring unit 512 a request item for which no corresponding function realizing unit 530 has been identified, and then create a list of such request items as unwanted data.

The lists generated by the unprocessed data list generating unit 515 are outputted to the response generating unit 513. The response generating unit 513 generates a response corresponding to the request item processed by the function realizing unit 530. The response generated by the response generating unit 513 may be based on the version of the image forming apparatus 500. The response generated by the response generating unit 513 may include a response item outputted by the function realizing unit 530. The response generating unit 513 may generate the response in the first description format by converting the data format of the function realizing unit 530 in which the response item is outputted by the function realizing unit 530. When the response item outputted by the function realizing unit 530 is in the second description format, the response generating unit 513 may acquire necessary information from the response item and include that information in a response in the first description format.

The response item may be in the second description format when the function realizing unit 530 has been later added to the image forming apparatus 500 so that, although its identifying information is registered in the list managing unit 541, no corresponding data format providing an interface between the data and the function realizing unit 530 is registered in the format retaining unit 542. Thus, a response corresponding to a response item outputted by a newly added function realizing unit 530 of the image forming apparatus 500 can be generated.

The response generating unit 513 may include unprocessed data in a response based on the unprocessed data list obtained from the unprocessed data list generating unit 515. In this case, the response generating unit 513 may clarify the unprocessed nature of the data using tags or the like. Thus, data that the image forming apparatus 500 has been unable to process can be included in the response, thereby allowing an administrator, for example, who has received the response to determine which data has been processed and which data has not been processed.

The message generating unit 514, based on a predetermined event in the image forming apparatus 500, may generate a message describing a status of the image forming apparatus 500 in a predetermined description format. The predetermined event may include the development of an error in the image forming apparatus 500, such as a door left open or a lack of paper. The message generated by the message generating unit 514 may include a status item outputted by the function realizing unit 530.

The message generating unit 514 may generate the message in the first description format by converting the data format of the function realizing unit 530 in which the status item is outputted by the function realizing unit 530. When the status item is outputted by the function realizing unit 530 in the second description format, the message generating unit 514 may acquire necessary information from the status item in the second description format and include the information in the message in the first description format. The status item may be in the second description format in a case similar to the above-described case where the response item is in the second description format. Thus, a message corresponding to the status item outputted by a newly added function realizing unit 530 of the image forming apparatus 500 can be generated.

The function realizing unit 530 executes a corresponding process based on the request item acquired by the processed content acquiring unit 512. For example, the function realizing unit 530 acquires information stored in a storage unit (not shown) and outputs it. The function realizing unit 530 may edit or substitute for information stored in the storage unit, or generate new information based on the request item and then store it in the storage unit. The storage unit may retain information concerning the status of the image forming apparatus 500, image data processed by the image forming apparatus 500, or information about an operator of the image forming apparatus 500. The function realizing unit 530, in addition to processing the information stored in the storage unit, may execute processes related to an image forming function, a communication function, or a facsimile function of the image forming apparatus 500. The function realizing unit 530 may be externally connected to the image forming apparatus 500.

The list managing unit 541 retains a list of the function realizing units 530 of the image forming apparatus 500. When a new function realizing unit 530 is added, the list is updated by the list managing unit 541. The data format retaining unit 542 retains data formats for the request item, the response item, and/or the status item corresponding to each of the function realizing units 530. Thus, the processed content acquiring unit 512, for example, can perform conversion between the first description format and the data format associated with each of the function realizing units 530 with reference to the data format retaining unit 542.

The communication unit 550 enables communication between the image forming apparatus 500 and the client PC 600 by, for example, receiving requests and transmitting responses or messages. The client PC 600 may transmit a request to the image forming apparatus 500 and receive a response in order to control the image forming apparatus 500 or manage information retained in the image forming apparatus 500.

The client PC 600 includes an information processing logic unit 610 and a communication unit 650. The information processing logic unit 610 may generate a request transmitted to the image forming apparatus 500 and analyze a response from the image forming apparatus 500 in order to determine a status of the image forming apparatus 500. The term “status” may refer to certain information retained in the image forming apparatus 500. The information processing logic unit 610 includes a request generating unit 611, a response analyzing unit 612, and a status acquiring unit 613. The request generating unit 611 may generate a request including a request item that is requested from the image forming apparatus 500. The request generated by the request generating unit 611 may be described in the first description format. The response analyzing unit 612 may analyze a response or a message transmitted from the image forming apparatus 500. Hereafter, the response analyzing unit 612 may be described with reference to a response; however, the same process may apply to a message. The response analyzing unit 612 may include an XML parser when the response is in XML.

The status acquiring unit 613 may acquire information about the status of the image forming apparatus 500 based on the response item or the status item analyzed by the response analyzing unit 612. The status acquiring unit 613 may assign the response item to a function realizing unit 630 based on the acquired status so that the function realizing units 630 can execute a process corresponding to the assigned response item. The status acquiring unit 613 converts the format of the response item to a data format corresponding to the function realizing unit 630. The status acquiring unit 613 may convert the response item into the second description format and then output it when the corresponding data format is not retained in a data format retaining unit 642.

The response item may be converted into the second description format in a case similar to the aforementioned case involving the image forming apparatus 500; i.e., when the response item corresponds to a newly added function realizing unit 630 of the client PC 600. Thus, a response item or a status item corresponding to a newly added function realizing unit 630 of the client PC 600 can be outputted so that a corresponding process can be executed.

Descriptions of the functions and structures of the function realizing unit 630, a list managing unit 641, the data format retaining unit 642, and the communication unit 650 are omitted because they are similar to those of the units of the image forming apparatus 500 having the same designations.

### Process Based On A Request From Client: Example 1

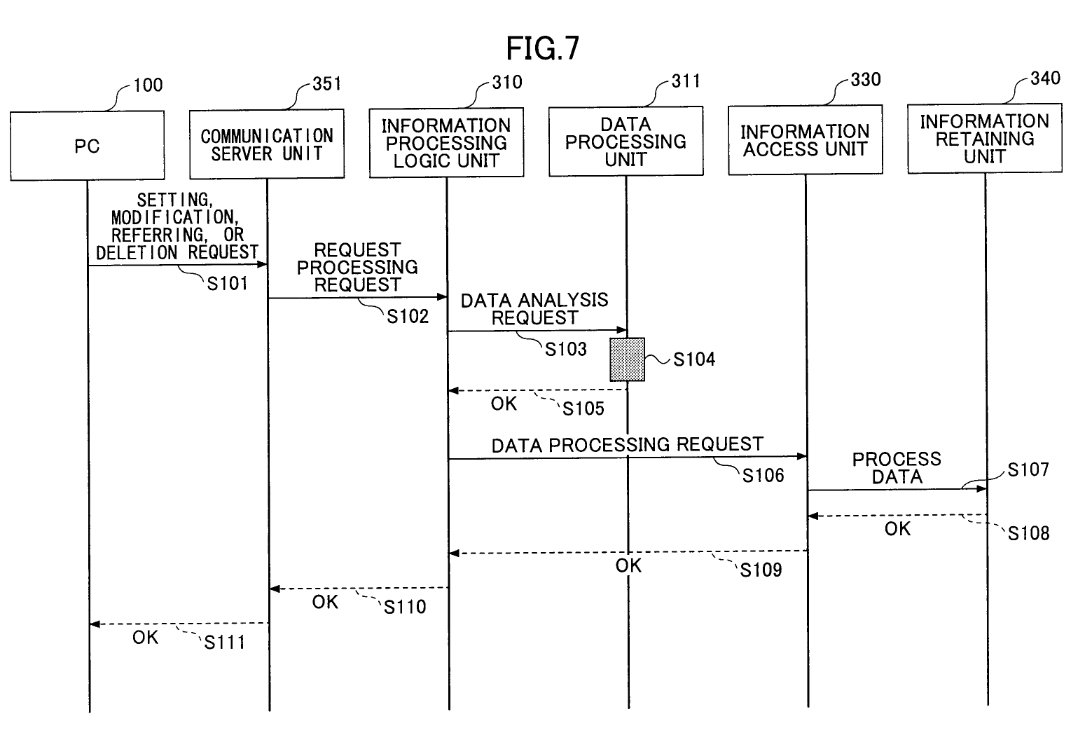

FIG. 7 is a sequence diagram of a process in the image forming apparatus 300 based on a request from the client. In step S101, the PC 100 (client) transmits a request to the server unit 351. The request may include a request item calling for the setting of a condition, or making a reference to, modification, or deletion of certain information. The request may be transmitted as an HTTP request, and may be described in the first description format using a description language such as XML.

In step S102, the server unit 351 requests the information processing logic unit 310 to process the request received in step S101. The request received in step S101 may call for a process of manipulating address book data retained in the information retaining unit 340 of the image forming apparatus 500. In step S103, the information processing logic unit 310 requests the data processing unit 311 to analyze data of the request. In step S104, the data processing unit 311 analyzes the request received in S101, thereby acquiring the request item contained in the request. The request may be described in an Atom format, such as an Atom Publishing Protocol (“APP”) format, or other extensible description format. Thus, the data processing unit 311 acquires the request item and identifying information of the function realizing unit 530 corresponding to the request item, in a particular description format. In the illustrated example, the identifying information of the information access unit 330 is acquired.

The data processing unit 311 converts the request item into the data format corresponding to the function realizing unit 530 identified by the identifying information, thereby generating processed content. When there is no data format corresponding to the function realizing unit 530, the data processing unit 311 converts the request item into the second, predetermined description format. The second description format may include the name of a namespace to which the request item belongs, a variable name or a tag name, and a value when the request is described in XML.

In step S105, the data processing unit 311 sends to the information processing logic unit 310 the generated processed content or the request item converted into the second description format, and a notice of end of analysis of the request. Thus, the information processing logic unit 310 acquires the processed content of the request item, or the request item in the second description format.

In step S106, the information processing logic unit 310 requests the information access unit 330 to execute the processed content. In step S107, the information access unit 330 accesses the information retaining unit 340 and executes a process based on the request received in step S101.

In step S108, the information retaining unit 340 outputs a notice of end of the process to the information access unit 330. In step S109, the information access unit 330 outputs a notice of end of the process to the information processing logic unit 310. In step S110, the information processing logic unit 310 requests the server unit 351 to notify the PC 100 of the end of the process. In step 15 S111, the server unit 351 transmits a notice of end of the process to the PC 100, in the form of an HTTP response, for example.

### Process Based On A Request From Client: Example 2

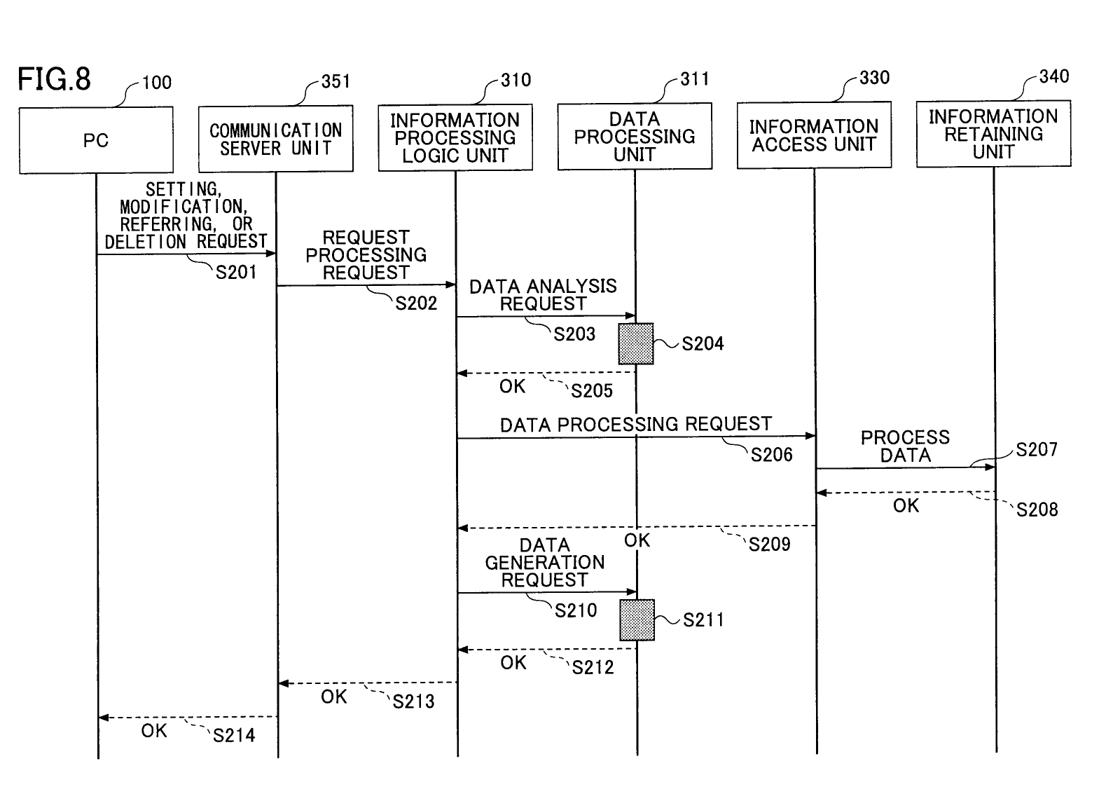

FIG. 8 is a sequence diagram of a process in the image forming apparatus 300 based on a request from the client, in which the image forming apparatus 300 transmits a response to the PC 100 (client). Descriptions of steps S201 through S208 are omitted because these steps are identical to the steps S101 through S108 of FIG. 7.

In step S209, the information access unit 330 outputs to the information processing logic unit 310 a response item indicating the end of process. The response item may be in the data format corresponding to the information processing logic unit 310, or in the second description format. The second description format may include the name of a namespace to which the response item belongs, a variable name or a tag name, and a value when the response is in XML. In step S210, the information processing logic unit 310 requests the data processing unit 311 to generate a response. The information processing logic unit 310 may also send an unprocessed data list to the data processing unit 311.

In step S211, the data processing unit 311 generates a response including a response item corresponding to the processed content executed in step 204. The response may be described in the first description format using XML. More specifically, the response may be described in an Atom format such as an APP format, or other extensible format. The format used may depend on the contents of the request indicating a preferred format for a response, or on the environment of support for the format of the image forming apparatus. The data processing unit 311, when having acquired the unprocessed data list from the information processing logic unit 310, may include unprocessed data (response item) in the response based on the unprocessed data list.

In step S212, the data processing unit 311 outputs a notice indicating the end of generation of a response and the response to the information processing logic unit 310. The output of the response may also serve as the notice of end of generation of the response. In step S213, the information processing logic unit 310 outputs to the server unit 351 the response and a request for transmitting the response. In step S214, the server unit 351 transmits the response to the PC 100.

### Process of Generating And Transmitting A Message

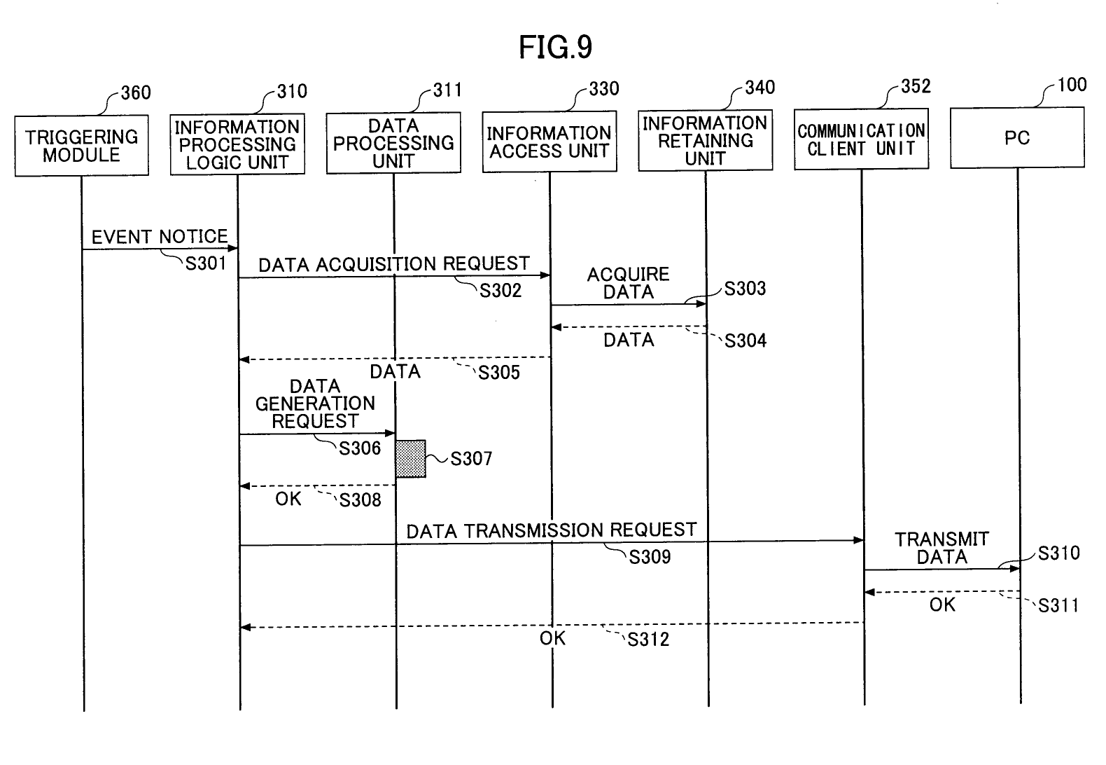

FIG. 9 is a sequence diagram of a process of transmitting a message from the image forming apparatus 500 to the PC 100 based on a predetermined event, such as the presence of abnormality.

In step S301, a triggering module notifies the information processing logic unit 310 of the development of the event, such as a door of the image forming apparatus 500 left open. In step S302, the information processing logic unit 310 sends a data acquiring request to the information access unit 330. This is because the details of the event can be obtained by referring to the information retained in the information retaining unit 340. In step S303, the information access unit 330 sends a data request to the information retaining unit 340. In step S304, the information retaining unit 340 outputs relevant data to the information access unit 330, the data containing detailed information about the event.

In step S305, the information access unit 330 outputs the data obtained in step S304 to the information processing logic unit 310. The data outputted by the information access unit 330 may be in a data format corresponding to the information access unit 330, or the second description format. In step S306, the information processing logic unit 310 outputs a message generation request to the data processing unit 311. In step S307, the data processing unit 311, based on the detailed information contained in the data outputted by the information access unit 330, generates a message in a predetermined description format. In step S308, the data processing unit 311 outputs the message and a notice indicating the end of the message creating process to the information processing logic unit 310. The output of the message may also serve as such a notice.

In step S309, the information processing logic unit 310 outputs a message transmission request to the client unit 352. In step S310, the client unit 352 outputs the message to the PC 100, in the form of an HTTP request, for example. In step S311, the PC 100 transmits a message reception notice to the client unit 352. The notice may be transmitted as an HTTP response. In step S312, the client unit 352 notifies the information processing logic unit 310 that the message has been received.

### Process of Analyzing Request

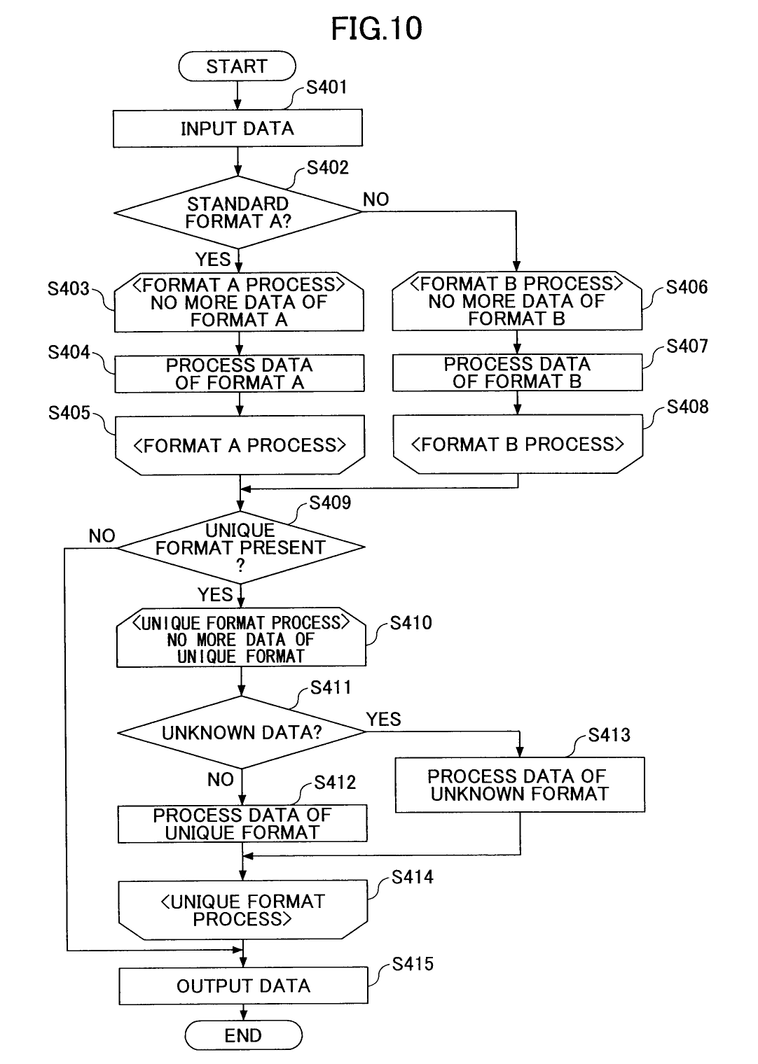

FIG. 10 is a flowchart of a process of analyzing a request in the information processing logic unit 310 and the data processing unit 311. The process of FIG. 10 may be executed by the request analyzing unit 511 in step S104 of FIG. 7 or in step S204 of FIG. 8. In step S401 of FIG. 10, a request is inputted to the data processing unit 311.

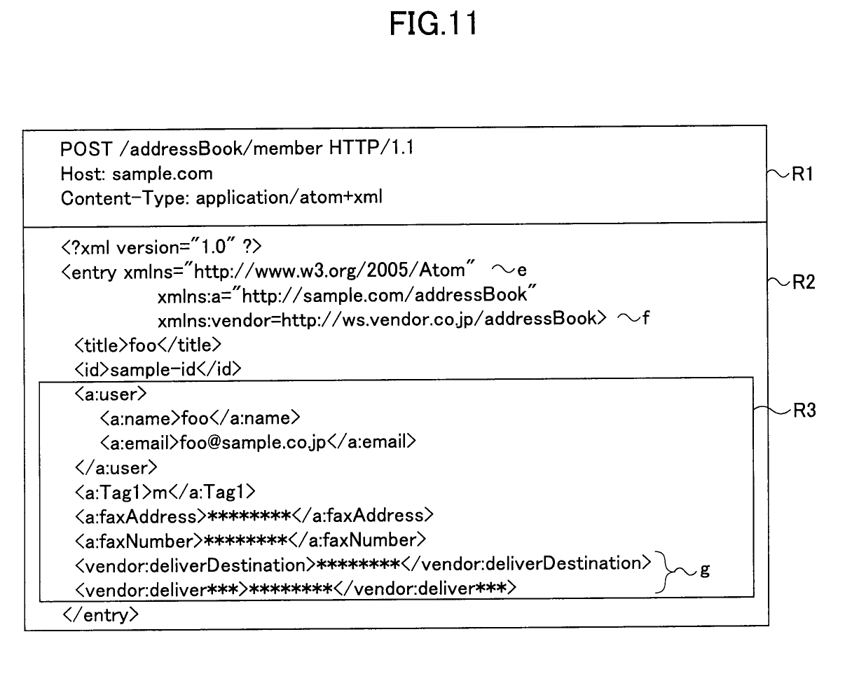

FIG. 11 depicts an example of the request, calling for the addition of a new record in an address book retained in a storage unit or the like (not shown) of the image forming apparatus 500. Such a storage unit may be part of the data format retaining unit 542. The request of FIG. 11 includes an HTTP request header portion R1 and a main body R2 including a request item. A description in a portion “e” in the main body R2 indicates that this request is described in an Atom format and an extended format defined by a namespace “a” and a namespace “vendor”. The extended format defined by the namespace “vendor” corresponds to a request item for a newly added function in the present embodiment.

In FIG. 11, R3 indicates an area described in the extended format. The area R3 includes record information such as a mail address and a facsimile number of the name “foo”, each as a request item. The area R3 further includes values in a portion “g” having tags identified by the namespace “vendor”.

Referring back to FIG. 10, in step S402, the request analyzing unit 511 analyzes the request from its start, to determine a standard format portion. In the illustrated example, it is determined whether the standard format is format A or format B. If the standard format is format A, the flow branches to step S403; if it is format B, the flow proceeds to step S406. The standard format may refer to a general standard such as APP or Atom when the request is described in XML. In another embodiment, one or more of three or more of standard formats may be processed, rather than processing one of two standard formats.

In steps S403 through S405, the request analyzing unit 511 acquires a request item from a portion of the request described in format A. Then, the processed content acquiring unit 512 acquires the processed content of the request item. The processed content thus acquired is in a data format corresponding to the function realizing unit 530. The above process is repeated until all of the portions of the request described in format A are processed. The identifying information of the function realizing unit 530 is acquired by the request analyzing unit 511. The identifying information of the individual function realizing unit 530 may be included in each request item in the request, or included in association with each description format in the request. In steps S406 through S408, regarding portions described in format B, the request analyzing unit 511 and the processed content acquiring unit 512 perform processes similar to those performed in steps S403 through S405.

After the portions described in the standard format have been processed, the routine proceeds to process a unique format. In step S409, the request analyzing unit 511 determines whether there is a unique format in the request. If there is a unique format, the routine proceeds to step S410; if not, it proceeds to step S414. Alternatively, in step S409, instead of the unique format determination, it may be determined whether there is a group of request items corresponding lS to a function handled by the image forming apparatus 500. If there is a group of request items corresponding to a function handled by the image forming apparatus 500, the routine proceeds to step S410; if not, to step S415.

In steps S410 through S414, the request analyzing unit 511 repeats the process of acquiring the request items contained in the request until all of the request items are acquired. Each time a request item is acquired, the processed content acquiring unit 512 in step S411 determines whether a data format corresponding to the request item is registered. If the corresponding data format is registered, the routine proceeds to step S412; if not, to step S413.

In step S412, the processed content acquiring unit 512 acquires the processed content in the corresponding data format of the function realizing unit 530. On the other hand, in step S413, the processed content acquiring unit 512 converts the request item into the second description format.

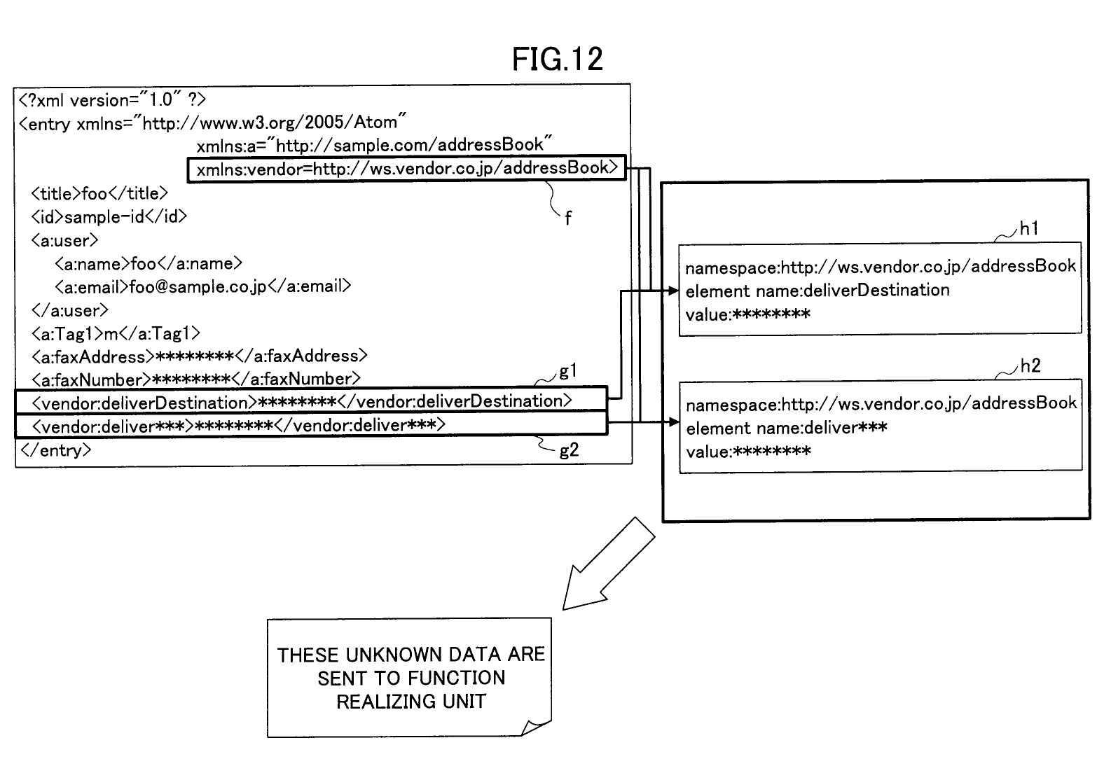

FIG. 12 illustrates a process of converting a request item into the second description format. As illustrated, a namespace given a code f and an element given a code g1 form a request item h1. A namespace given a code f and an element given a code g2 form a request item h2.

Thus, even when the request includes a request item requiring a function that is not registered in the image forming apparatus 500, execution of that function can be requested. Thus, when the image forming apparatus 500 has a newly added function realizing unit 530, the client device or the like can generate and output a request for the corresponding newly added function.

Referring back to FIG. 10, after step S409 or S413, the routine proceeds to step S414 where the acquired processed content is outputted to the information processing logic unit 310.

### Request Containing Data That Results In Unprocessed Data

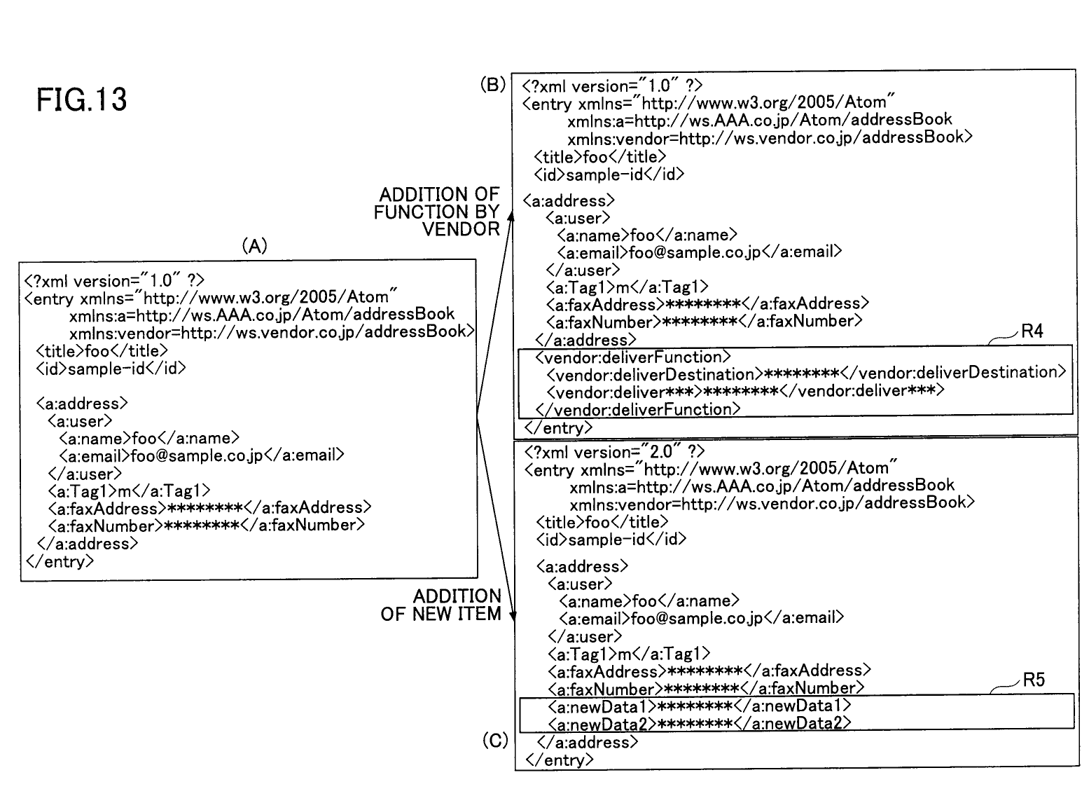

FIGS. 13(A) and 13(B) depict examples of requests that contain data (request items) that result in unprocessed data. FIG. 13(A) depicts a request described using Atom and an extended format defined by a namespace “a”.

FIG. 13(B) depicts a request described in an Atom format and an extended format defined by a namespace “a” and a namespace “vendor”. In this case, R4 indicates a portion that is described in the extended format defined by the namespace “vendor”. Thus, R4 is unwanted data to the image forming apparatus 500 if it has no function provided by the vendor.

FIG. 13(C) depicts a request described in an Atom format and an extended format defined by the namespace “a”. In this case, R5 indicates a portion describing new items added by version upgrade. Thus, R5 is unsupported data to the image forming apparatus 500 if it is only compatible with an older version.

### Process of Generating A Response Or A Message

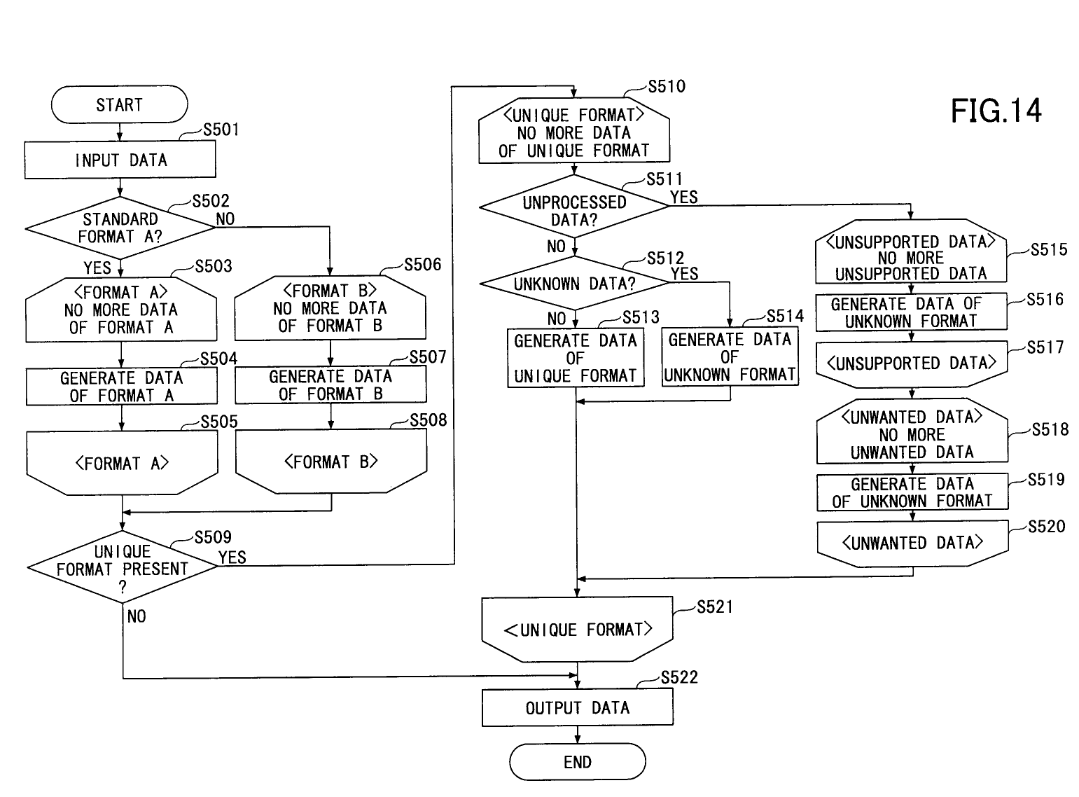

FIG. 14 is a flowchart of a process in the information processing logic unit 310 and the data processing unit 311 in which a response or a message is generated. The process of FIG. 14 may be performed by the response generating unit 513 in step S211 of FIG. 8, or by the message generating unit in step S307 of FIG. 9. In the example described below, the process is performed by the response generating unit 513.

In step S501, data of a response item contained in a response is entered from the information processing logic unit 310 into the data processing unit 311. If there is an unprocessed data list, the unprocessed data list is also entered. In step S502, the response generating unit 513, based on the entered data, selects a description format for a response. In the illustrated example, a standard format portion is selected. If the standard format is described in format A, the routine proceeds to step S503. If the standard format is described in format B, the routine proceeds to step S506. In another embodiment, one or more of multiple standard formats may be selected, instead of selecting one from two standard formats, in order to generate a response described in the one or more selected standard formats.

In steps S503 through S505, the response generating unit 513 generates data describing the response item in format A until there are no more response item data to be described in format A. Similarly, in steps S506 through S508, data describing the response item in format B are generated until there is no more response item data to be described in format B. In step S509, the response generating unit 513 determines whether there are response item data to be described in a unique format. If there is, the routine proceeds to step S510; if not, to step S522.

In steps S510 through S521, the response generating unit 513 repeats the process of describing response items in the unique format or in an unknown format until there is no more response item data that needs to be described in the unique format or the unknown format. In step S511, it is determined whether the response generating unit 513 has acquired the unprocessed data list from the unprocessed data list generating unit 515. If the unprocessed data list has been acquired, the routine proceeds to step S515; if not, to step S512.

In step S512, it is determined whether the response item includes unknown data. The unknown data may include data of a response item having no preregistered data format. The unknown data may be described in the second description format, which may include a namespace name, a variable name or a tag name, and a value.

If the data is known data, the routine proceeds to step S513; if it is unknown data, the routine proceeds to step S514. In step S513, the response generating unit 513 generates a response in the first description format by referring to the data format of the acquired response item. On the other hand, in step S514, the response generating unit 513 generates a response in the first description format from the second description format of the acquired response item.

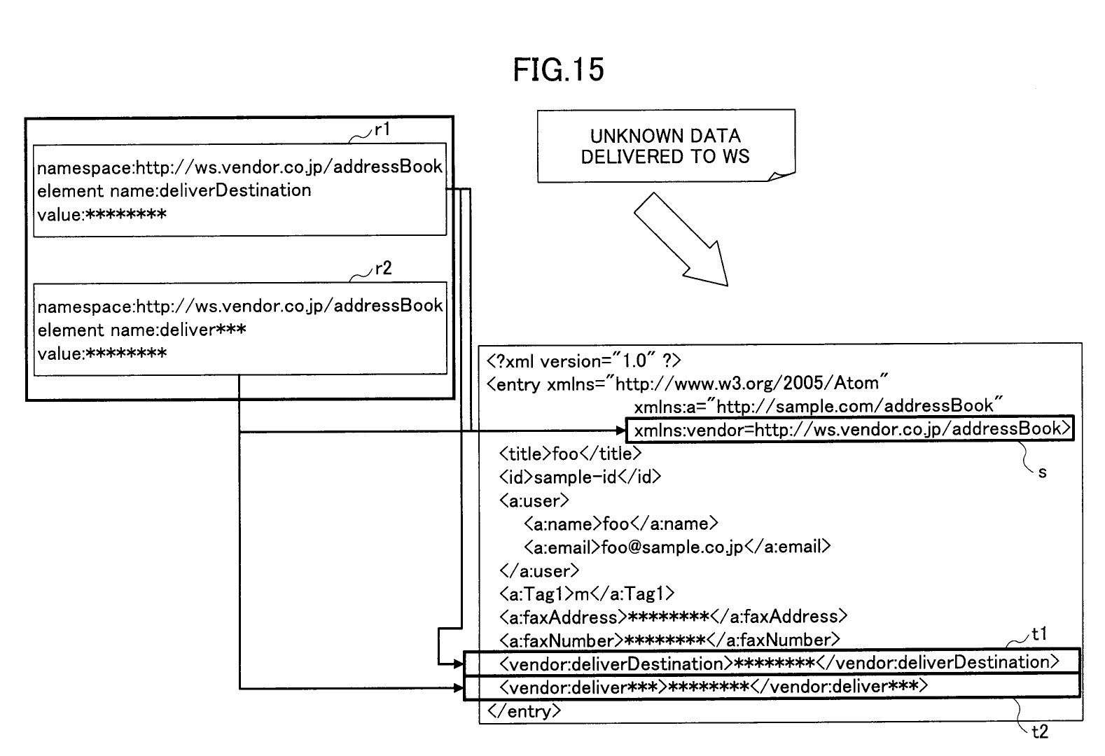

FIG. 15 illustrates a process of generating a response in the first description format from a response item in the second description format. As illustrated, a namespace “s” and an element “t1” are generated from a response item given a code “r1”, while a namespace “s” and an element “t2” are generated from a response item given a code “r2”.

Referring back to FIG. 14, in steps S515 through S517, the response generating unit 513 repeats the process of describing the data in the unsupported data list as unsupported data, until there is no unsupported data. In steps S518 through S520, the response generating unit 513 repeats the process of describing the data in the unwanted data list as unwanted data, until there is no unwanted data. As mentioned above, the unprocessed data includes unsupported data and unwanted data.

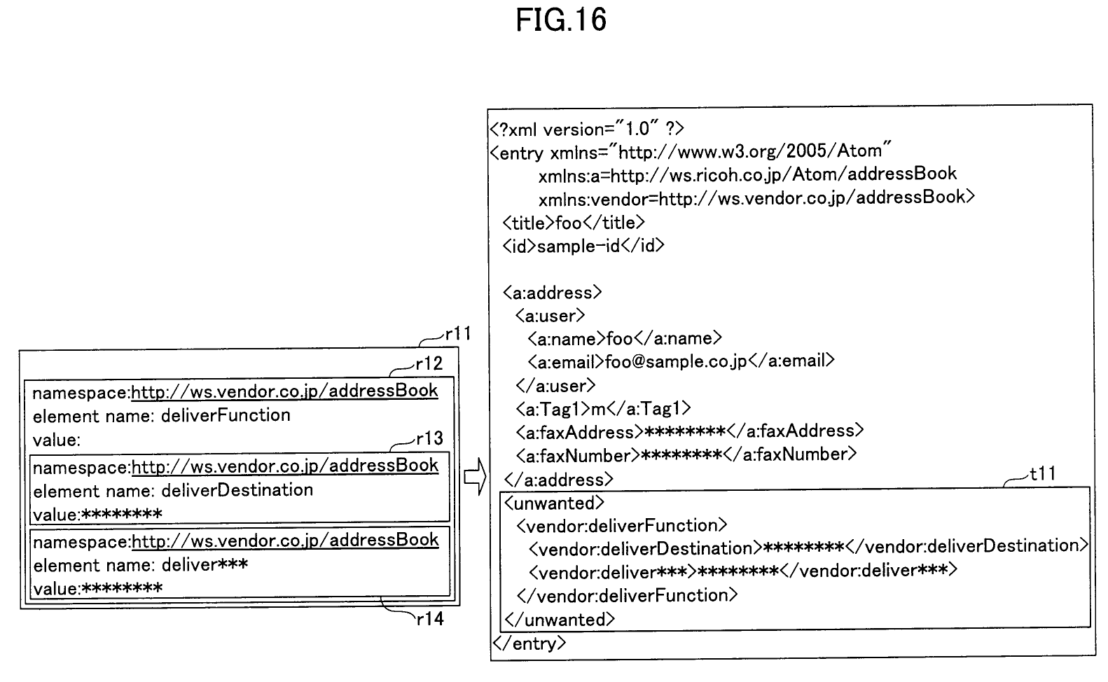

FIG. 16 illustrates a process of generating a response in the first description format from a response item based on the unwanted data list (second description format). Specifically, an element r11 in the first description format is generated from a response item in the second description format that is given a code r11.

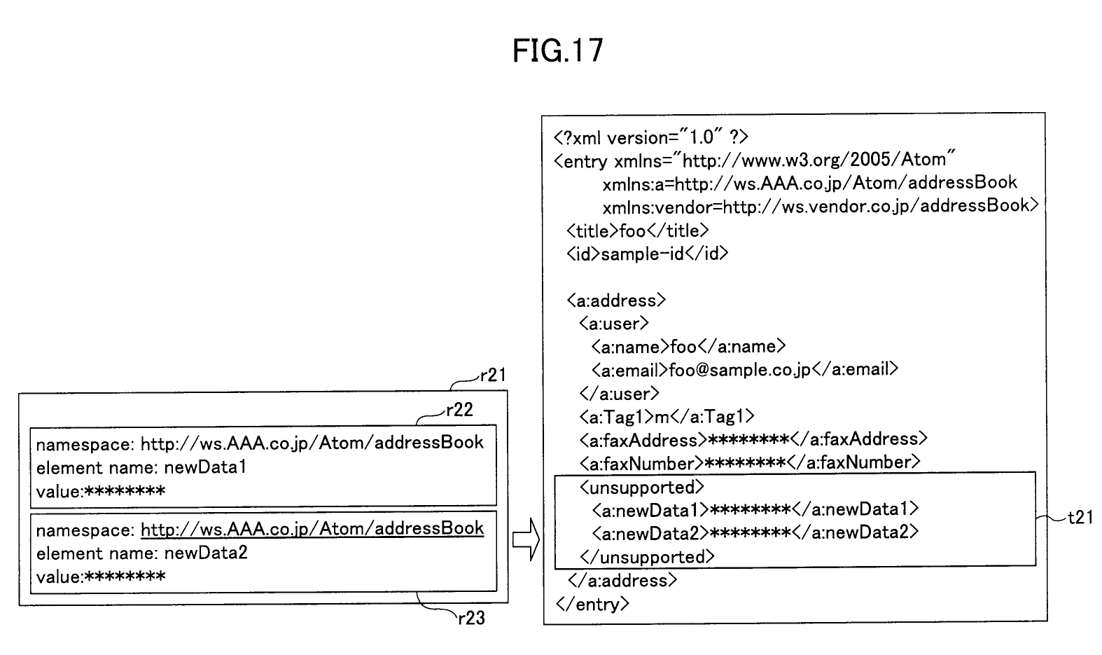

FIG. 17 illustrates a process of generating a response in the first description format from a response item based on the unsupported data list (second description format). Specifically, an element t21 in the first description format is generated from a response item in the second description format that is given a code r21.

Referring back to FIG. 14, in step S522 following either step S509 or S521, the response generated by the response generating unit 513 is outputted to the information processing logic unit 310.

### Response

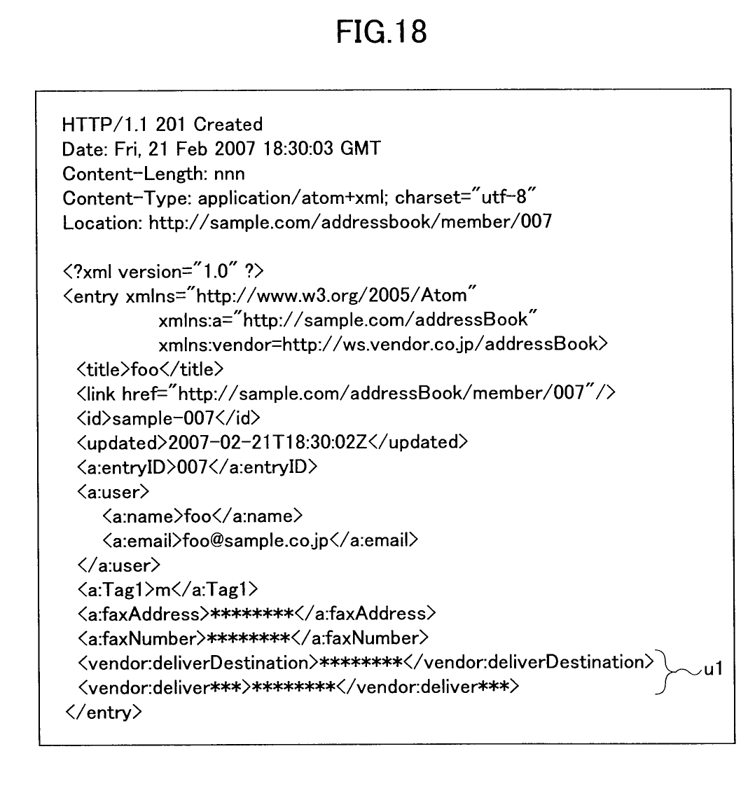

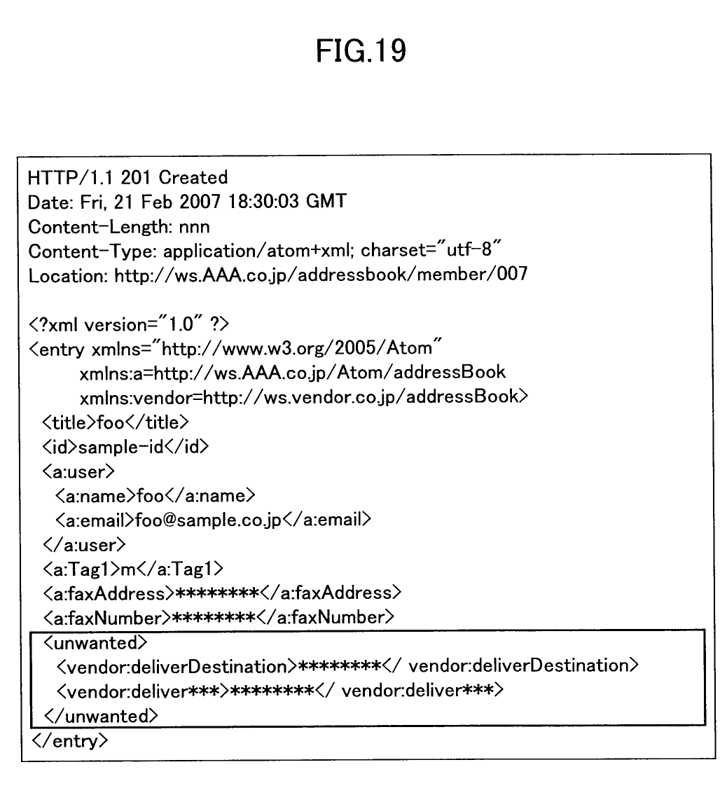

FIGS. 18 and 19 depict response examples. FIG. 18 depicts an exemplary response generated in response to the request of FIG. 11. The response of FIG. 18 includes content that has been processed in accordance with the request of FIG. 11. Specifically, the response of FIG. 18 includes the content of the record added in the address book, such as the name “foo”, a mail address and a facsimile number associated with the name, each as an individual response item. In a portion indicated by a code u1, there is contained a response item for manipulating the address book identified by the namespace “vendor”.

FIG. 19 depicts another example of the response generated in response to the request of FIG. 11. The response of FIG. 19 includes “deliverDestination” and “deliver***” tags described within the “unwanted” tags. This indicates that these tags have not been processed because the image forming apparatus that generated the response of FIG. 19 does not include a function of retaining data indicated by the namespace “vendor”. Namely, the <unwanted> tags indicate the absence of the relevant function in the first place.

When the data in the address book is edited, HTTP “PUT” may be used for inputting a request and outputting a response. When reference is made to data in the address book, HTTP “GET” may be used for outputting response data. When deleting data in the address book, HTTP “DELETE” may be used, without involving an exchange of request and response data.

### Message

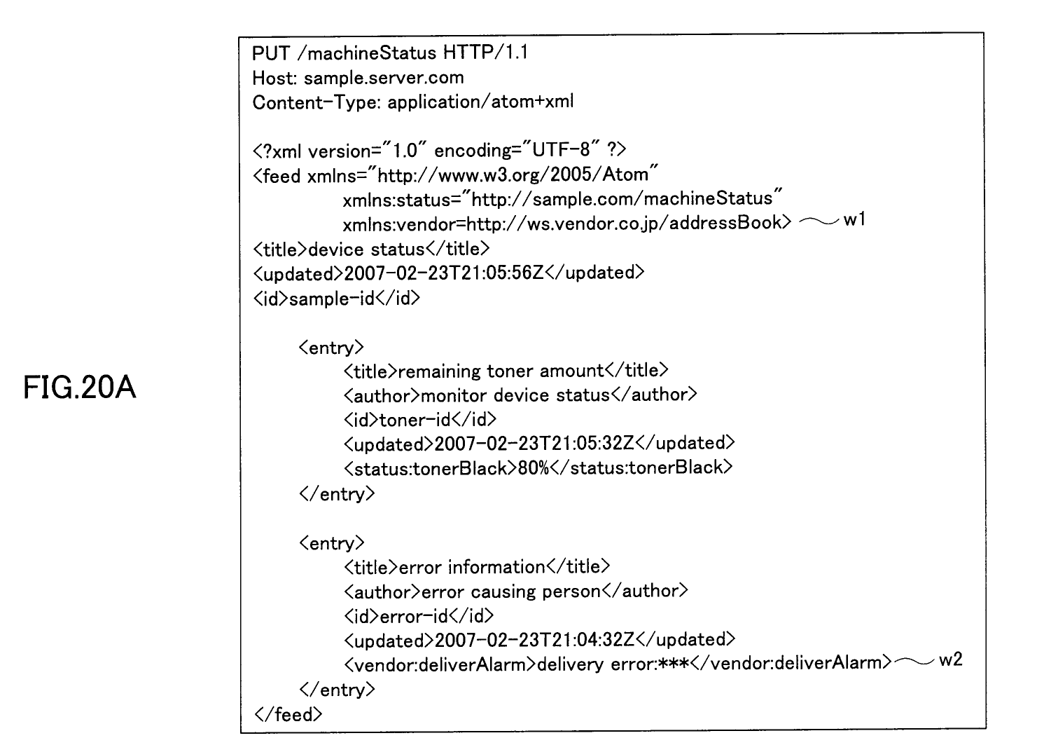

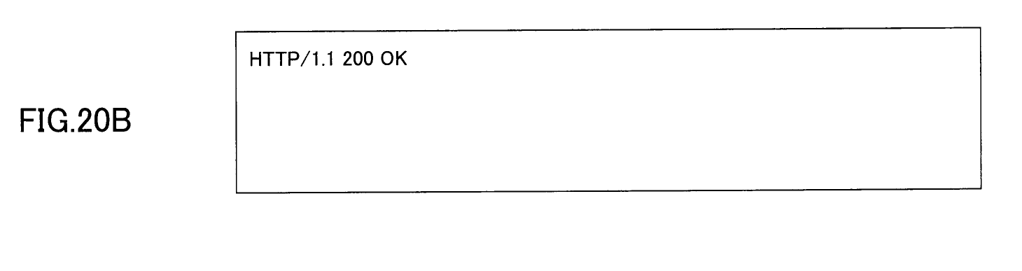

FIG. 20A depicts an example of a message notifying the client PC about the development of abnormality in the image forming apparatus. FIG. 20B depicts an example of a response outputted from the client PC in response to the message of FIG. 20A. In the example of FIG. 20A, the namespace given a code w1 and the element given a code w2 are the response items obtained by converting from the second description format. In the illustrated example, the message is transmitted as an HTTP request and a response is returned as an HTTP response.

### Computer Configuration

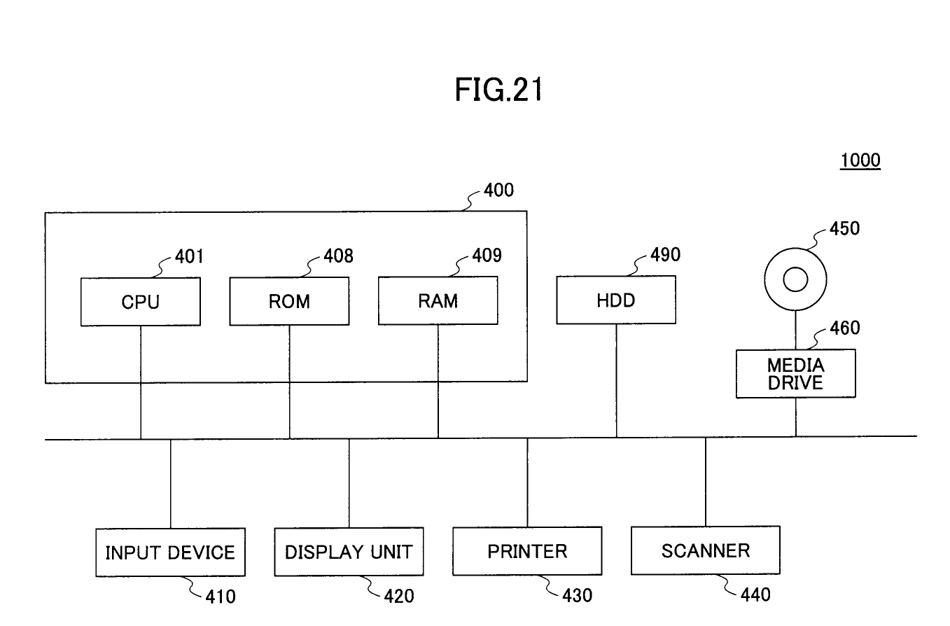

FIG. 21 is a block diagram of a computer 1000 for realizing the image forming apparatus or the client device according to an embodiment. The computer 1000 includes a main processing unit 400, an input device 410, a display unit 420, a printer 430, a scanner 440, and a HDD 490. The main processing unit 400, which is a main portion for realizing the functions of the computer, includes a CPU 401, a ROM 408, and a RAM 409. The CPU 401 may read a computer program from the ROM 408 and load it into the RAM 409 in order to execute the computer program. The ROM 408, which is a nonvolatile memory, may store the program executed by the CPU 401, or parameters necessary for controlling the image forming apparatus or the client device. The RAM 409 provides a work memory for a process executed by the CPU 401.

The input device 410 may include a keyboard used by an operator for the input of instructions. The display unit 420 may display the status of the computer. The printer 430 includes an output device for forming an image on a medium. The scanner 440 includes a device for optically reading the image formed on the medium. The HDD 490 may store a large volume of data, such as image data.

A computer program according to an embodiment of the present invention may be stored in a recording medium 450 that can be read via a media drive unit 460, as well as being stored in the HDD 490 or the ROM 408. Thus, in accordance with an embodiment of the present invention, an image forming apparatus to which a new function has been added analyzes the contents of a request and processes the request appropriately.

Although this invention has been described in detail with reference to certain embodiments, variations and modifications exist within the scope and spirit of the invention as described and defined in the following claims.

The present application is based on the Japanese Priority Application No. 2009-046564 filed Feb. 27, 2009, the entire contents of which are hereby incorporated by reference.

What is claimed is:

1. An image forming apparatus comprising:
a function realizing unit configured to perform a function in accordance with a request item contained in a request sent from a client device connected to the image forming apparatus;
a communication unit configured to receive the request from the client device in a first description format;
a request analyzing unit configured to analyze the request received by the communication unit to acquire identifying information of the function realizing unit and the request item from the request;
a data format retaining unit configured to retain a corresponding data format for the function realizing unit;
a processed content acquiring unit configured to acquire processed content by converting a format of the request item into the corresponding data format of the function realizing unit that is retained in the data format retaining unit, based on an output of the request analyzing unit, the processed content acquiring unit being configured to convert the format of the request item into a second description format when the corresponding data format is not retained in the data format retaining unit; and
a response generating unit configured to generate a response in the first description format based on a response item that is outputted by the function realizing unit in the corresponding data format or in the second description format when the corresponding data format is not retained in the data format retaining unit,
wherein the response item is described in the response indicating whether the request item has been processed by the function realizing unit.

2. The image forming apparatus according to claim 1, wherein the response item in the response includes a first response item that has not been processed by the function realizing unit due to the absence of one of plural of the function realizing units, the one corresponding to the request item, and a second response item that has not been processed by the function realizing unit due to the function realizing unit being unable to process the request item,
wherein the response generating unit is configured to generate the response in which the first response item and the second response item are distinguished.

3. The image forming apparatus according to claim 1, wherein the request item belongs to one of plural groups of the request items, and wherein the request includes request items from one or more of the groups of the request items.

4. The image forming apparatus according to claim 3, wherein the processed content acquiring unit is configured to determine the presence or absence of the corresponding data format based on the group of items to which the request item belongs.

5. The image forming apparatus according to claim 1, wherein the response item belongs to a group of items to which the request item of the processed content corresponding to the response item belongs.

6. The image forming apparatus according to claim 1, the image forming apparatus further comprising a message generating unit configured to acquire from the function realizing unit a status item related to a status of the function realizing unit in the corresponding data format retained in the data format retaining unit and/or the second description format, and configured to generate a message in which the status item is in the first description format,
wherein the communication unit is configured to transmit the message to the client device.

7. The image forming apparatus according to claim 3, wherein the first description format is based on XML, and wherein each of the groups of items is identified by a namespace.

8. The image forming apparatus according to claim 1, wherein the communication unit is configured to receive the request in accordance with a predetermined protocol.

9. The image forming apparatus according to claim 1, wherein the communication unit is configured to communicate with the client device in accordance with a predetermined interface.

10. An image forming system comprising a client device and an image forming apparatus connected to the client device,
wherein the client device includes:
a request generating unit configured to generate a request containing a request item in a first description format; and
a first communication unit configured to transmit the request to the image forming apparatus,
wherein the image forming apparatus includes:
a function realizing unit configured to perform a function in accordance with the request item contained in the request sent from the client device;
a second communication unit configured to receive the request from the client device in the first description format;
a request analyzing unit configured to analyze the request received by the second communication unit to acquire identifying information of the function realizing unit and the request item from the request;
a data format retaining unit configured to retain a corresponding data format for the function realizing unit;
a processed content acquiring unit configured to acquire processed content by converting a format of the request item into the data format of the function realizing unit that is retained in the data format retaining unit, based on an output of the request analyzing unit, the processed content acquiring unit being configured to convert the format of the request item into a second description format when the corresponding data format is not retained in the data format retaining unit; and
a response generating unit configured to generate a response in the first description format based on a response item that is outputted by the function realizing unit in the corresponding data format or in the second description format when the corresponding data format is not retained in the data format retaining unit,
wherein the response item is described in the response indicating whether the request item has been processed by the function realizing unit.

11. An information processing method for an image forming apparatus including a function realizing unit and a data format retaining unit configured to retain a corresponding data format for the function realizing unit,
the method comprising:
receiving a request from a client device in a first description format, the request containing a request item;
analyzing the request received from the client device to acquire identifying information of the function realizing unit and the request item from the request;
acquiring processed content by converting a format of the request item into the corresponding data format of the function realizing unit that is retained in the data format retaining unit, based on an output of the analysis;
converting the format of the request item into a second description format when the corresponding data format is not retained in the data format retaining unit;
generating a response in the first description format based on a response item that is outputted by the function realizing unit in the corresponding data format or in the second description format when the corresponding data format is not retained in the data format retaining unit; and
indicating in the response whether the request item has been processed by the function realizing unit.
